(19) United States
(12) Patent Application Publication
(10) Pub. No.: US 2008/0117416 A1
(43) Pub. Date: May 22, 2008

(54) USE OF COHERENT RAMAN TECHNIQUES FOR MEDICAL DIAGNOSTIC AND THERAPEUTIC PURPOSES, AND CALIBRATION TECHNIQUES FOR SAME

(76) Inventors: Ian W. Hunter, Lincoln, MA (US); Shyamal Somaroo, West New York, NJ (US); Serge Lafontaine, Lincoln, MA (US); Patrick A. Anquetil, Brookline, MA (US); Ching-Hua Tseng, Belmont, MA (US)

Correspondence Address: WILMERHALE/DC, 1875 PENNSYLVANIA AVE., NW, WASHINGTON, DC, 20004, US

(21) Appl. No.: 11/927,557

(22) Filed: Oct. 29, 2007

Related U.S. Application Data
(60) Provisional application No. 60/855,032, filed on Oct. 27, 2006.
(60) Provisional application No. 60/855,033, filed on Oct. 27, 2006.

(51) Int. Cl. G01J 3/44

(52) U.S. Cl. 356/301

(57) ABSTRACT

System and methods are provided to perform non-invasive, real-time, continuous molecular detection and quantification of molecular species in a sample or animal subject using Raman spectroscopy. Such systems and methods may be applied to identify and quantify molecular species found in the body, which may be useful for prenatal diagnosis, detecting deep skin infections, performing cerebral spinal fluid assessment, measuring arterial blood gases, blood glucose, cardiac biomarkers, creatinine flow rates. The non-invasive, quantification of such molecular species continuously in real time enables a significantly more attractive course of therapy than existing protocols.

### CROSS-REFERENCE TO RELATED APPLICATIONS

This application claims priority from U.S. Provisional Patent Application Ser. No. 60/855,032, filed on Oct. 27, 2006 and entitled “Use of Coherent Raman Techniques for Medical Diagnostic and Therapeutic Purposes,” and from U.S. Provision Patent Application Ser. No. 60/855,033, filed on Oct. 27, 2006 and entitled “Method to Calibrate a Non-Invasive Molecular Diagnostic Device, both of which are wholly incorporated herein by reference.

This application is related to U.S. patent application Ser. No. (TBA), filed concurrently herewith and entitled “Use of Quantum Control Techniques for Medical Diagnostic and Therapeutic Purposes,” the entire contents of which are incorporated herein by reference.

### AREA OF TECHNOLOGY

The invention relates to spectroscopic techniques to study molecules using Raman scattering.

### BACKGROUND

Raman spectroscopy is a type of spectroscopy that utilizes the vibrational spectra of molecules to help characterize and identify species of interest. Coherent Raman techniques offer potentially stronger signal strength and better background rejection than spontaneous, or incoherent Raman. The two forms of Raman spectroscopy are distinguished by the nature of the light generation. Spontaneous Raman spectroscopy measures the spontaneous inelastic scattering of photons from molecular vibrations. Coherent Raman spectroscopy involves macroscopic oscillations of molecular polarization induced by laser fields with a frequency difference tuned near a vibrational resonance.

Coherent Raman techniques are non-linear optical spectroscopic techniques that return an optically coherent response, which depends on the third order susceptibility of a sample (see, e.g., Shen, Y. R. The Principles of Nonlinear Optics (John Wiley & Sons Inc. New York, 1984), pp. 267-275). These coherent techniques generally involve multiple pump and probe lasers at various frequencies. In addition to the optical coherent response, a sample will also usually exhibit a large non-resonant background signal. To manage, reduce, or eliminate this background, various forms of coherent Raman techniques have been developed. These methods include, amongst others, coherent anti-Stokes Raman spectroscopy (CARS); coherent Stokes Raman spectroscopy (CSRS); frequency modulated CARS (FM-CARS) and CSRS (FM-CSRS); epi-CARS, epi-CSRS; polarization CARS/CSRS; time-resolved CARS/CSRS; Interferometric CARS/CSRS; single-pulse CARS, CSRS; Fourier transform CARS, CSRS; and hybrid CARS/CSRS. Each of these methods can potentially enhance the signal from a sample by several orders of magnitude compared to spontaneous Raman spectroscopy, and thus reduce the time required to measure a sample. For strongly scattering media, however, many of these techniques are considered impractical because of the scrambling of spectral phases and polarization.

Non-invasive detection of physiological conditions is an attractive course of therapy over existing invasive protocols that may require, for instance, painful and potentially dangerous withdrawal of bodily fluid, such as blood, amniotic fluid, or spinal fluid. Many current proposals for non-invasive detection are either not sensitive to low levels of target molecules or cannot be calibrated to provide an absolute concentration value. Even for instances where an in vitro sample is available, a highly sensitive detection method may not allow for real-time analysis. Several examples are discussed below.

Prenatal diagnostics through chorionic villus sampling (CVS), amniocentesis, cordocentesis are commonly performed to rapidly verify the presence of Down syndrome or other fetal chromosomal abnormalities (18, 13), Tay-Sachs, cystic fibrosis, etc. These prenatal tests can also used to detect in fetuses the presence of infectious disease such as toxoplasmosis, rubella, or cytomegalovirus in the fetus, so that it can be treated, and to perform a blood count and check for anemia or low platelet levels. Unfortunately, the value of these diagnostics is counterbalanced by the unacceptably high risk of fetal loss at a rate of about one in two hundred.

Current non-invasive diagnostics, such as the triple or quad marker blood test coupled with other tests, such as ultrasound Nuchal translucency, free beta, PAPPA screens have a detection rate of only about 90-95%, with a false positive rate of 2-5%. A need therefore exists for a better way to discern chromosomal characteristics of the fetus without breaching the amniotic sac, or otherwise endangering the fetus. Although several methods to non-invasively measure fetal DNA have been explored, none employ an optical non-invasive measurement.

Bacterial or viral detection is another common concern for healthcare providers and consumers in general. In particular, bacterial infection of the deep skin, called cellulitis, involves a rapid and potentially life-threatening infection, which can result in an extreme medical emergency. Following infection, the disease may spread to the lymph nodes and bloodstream and/or involve necrotizing fasciitis. Possible causes include Group A streptococcus, Viblio vulnificus, Clostridium perfringens, Bacteroides fragilis, and/or Methicillin-resistant Staphylococcus aureus (MRSA). Cellulitis is often difficult to diagnose definitively and rapidly because its symptoms may resemble deep vein thrombosis or a rash caused by stasis dermatitis. Moreover, the bacterium causing the cellulitis is not easily cultured either by biopsy, wound culture, or saline wash. Further, blood tests are not effective unless the patient has developed general sepsis. Culturing can take 24-48 hours, but the disease may progress to mortality in 24 hours. It can thus be difficult to determine the severity of the health danger from the observed rash. A need exists to identify rapidly bacterial populations in the deep skin, and preferably to discern the class or specific strain of pathogen involved. Were such a diagnostic available, antibiotics such as penicillin, erythromycin and clindamycin, or cephalexin (Keflex) could be prescribed.

Lumbar punctures, also known as spinal taps, are often performed to withdraw cerebral spinal fluid (CSF) to help diagnose meningitis, subaraclmoid hemorrhage, hydrocephalus, benign intracranial hypertension, certain cancers, inflammation, Multiple Sclerosis/Guillian-Barre, neurosyphillis A, among others. Unfortunately, lumbar punctures creates the risk of epidural infection, paralysis, and paraplegia. A method of identifying molecules in CSF in situ without piercing the membrane protecting the central nervous system would reduce the risk of such complications.

Alzheimer's disease is clinically diagnosed based on the presence of characteristic neurological and neuropsychological features. Presently, no non-invasive or pre-mortem biomarker for Alzheimer's exists. Similarly, there are no known biomarkers for Parkinson's disease. An in situ method of monitoring CSF would be useful for evaluating drug response to new treatments of diseases, such Alzheimer's and Parkinson's disease.

Arterial blood gas measurements help doctors assess pulmonary function in patients, particularly those with persistent hypercapnic ventilatory failure during acute exacerbations of chronic obstructive pulmonary disease (AECOPD). Also, arterial blood gas (ABG) values are useful for the management of critically ill, ventilated patients in the neonatal intensive care unit (NICU). Generally, ABG values are obtained through arterial puncture blood draws. Repeated intermittent invasive arterial puncture carries inherent risks, including infection, pain, anemia. In pediatric patients, such repeated arterial punctures can be difficult, where dehydration increases the difficulty of blood draw. Moreover, frequent ABG sampling from a neonate results in blood loss that can necessitate transfusions and increase the risk of intravascular contamination. Low volume samplings are subject to errors, especially in blood electrolyte concentration measurements. In addition to the discomfort, health risks, and difficulty of administering the blood withdrawal, scheduled, or episodic ABG sampling may miss changing conditions. Rapid changes in blood gas values can occur following surfactant administration and during high-frequency ventilation. With continuous ABG monitoring, treatment modalities could be proactive rather than reactive. Although some transcutaneous devices to monitor carbon dioxide and oxygen levels have been developed, they require frequent site changes and recalibration of the probe, and can be contraindicated in hemodynamically compromised patients because of changes in blood flow to the tissues. Other devices, such as a pulse oximeter offers continuous estimation of blood oxygen saturation but give no information about pH or PaCO2.

Congestive heart failure (CHF) is the leading cause of hospitalization for persons over 65 years of age. Currently, blood withdrawn from the patient is tested to assess cardiac muscle damage, and to diagnose or stratify the patient's condition. This tests is performed over several hours to monitor the progression of analyte levels. Troponin levels indicating cardiac muscle damage will remain elevated for 1-2 weeks after a heart attack. Providing real time quantitative determination of cardiac biomarkers such as creatine kinase (CK-MB), myoglobin, troponin I, B-type Natriuretic Peptide (BNP), aspartate transaminase, or lactate dehydrogenase would aid in the diagnosis and treatment of acute myocardial infarction (MI), congestive heart failure (CHF), or stratification of acute coronary syndromes (ACS). Some of the same cardiac biomarkers may, however, reflect skeletal muscle injury. A need exists for a way to distinguish acute MI, CHF, or ACS, from skeletal muscle injury. Real time, and continuous time course data histories would aid in the differential diagnosis. Current known and proposed methods to monitor biomarkers, however, are episodic and time-delayed.

Diabetes, a condition resulting from the body's incapacity to regulate glucose, afflicts 150 million people worldwide with China, India and the US most affected. In the US alone, 21 million individuals suffer from this disease. It is expected that the number of diabetics will grow at an annual rate of 10% as the population ages and life expectancy increases. Alarmingly, incidence in children and young adults is also rising. Diabetics risk many short and long-term secondary complications, including blindness, amputation and nerve damage. Proper disease management via frequent monitoring of blood glucose levels is thus paramount. Unfortunately, the current commonly used method of measuring blood glucose levels by means of an invasive fingertip blood draw does not facilitate patient compliance for several reasons. Often, a patient will choose to put off the immediate pain, discomfort, and inconvenience of a finger prick test even though the long-term medical consequences are severe. Furthermore, the steps to withdraw blood can be difficult for many, especially those suffering tactile and vision impairments as a result of the disease. Finally, patients often find the information thus obtained not useful because it provides only a snapshot and fails to identify or predict periods of dangerous hypoglycemia (too little glucose) and hyperglycemia (too much glucose). Not surprisingly, less than 30% of patients consistently check their glucose levels one or more times a day, even though doctors recommend that patients monitor and control their blood sugar levels seven times a day. Thus, monitoring compliance remains a major issue in effective management of this disease. No non-invasive means of measuring glucose concentrations currently exists or have been proposed that would allow accurate and quantitative measurement of the glucose levels in diabetics.

Renal function is indicated by the glomerular filtration rate, which in turn is approximated by the creatinine filtration rate. The ability to measure directly creatinine levels in urine in real time would enable the early detection of renal failure. Currently, renal function is generally evaluated by collecting urine for 24 hours and measuring the serum creatinine concentration. Often, doctors require a faster diagnostic, particularly if renal therapy is required. Efforts have been made to estimate mathematically the kidney function or the glomerular filtration rate via the Cockcroft-Gault equation, and refinements thereon. A need exists for a way to perform real time measurements of the urine creatinine concentration and urine flow to determine creatinine flow rate directly.

In addition to cardiac biomarkers and ABG, other measures of blood, such a complete blood count (CBC), which measures a patient's Hgb (hemoglobin), WBC (white blood cells), Plt (platelet), Hct (hematocrit) values have conventionally required a blood draw. A CBC is performed via automated (flow cytometry) or manual (blood film) counting. A non-invasive means of obtaining information regarding blood analytes would be desirable, especially in pediatric cases, for many of the same reasons discussed above.

### SUMMARY

Embodiments of the invention provide coherent Raman techniques for medical diagnostic and therapeutic purposes, and calibration techniques for same.

Under one aspect, a method to measure the concentration of a target analyte in an animal subject using Raman spectroscopy includes measuring ex vivo a concentration of a target analyte in an animal subject; illuminating a portion of said animal subject with light so as to cause radiation to scatter from said reference analyte and said target analyte in said sample; detecting said scattered radiation from said reference analyte and from said target analyte; measuring an electrical signal corresponding to an amount of detected radiation from said reference analyte; measuring an electrical signal corresponding to an amount of detected radiation from said target analyte; calculating an attenuation factor based on said signal from said reference analyte; correcting the signal of said target analyte based on the attenuation factor; and determining an absolute concentration of said target analyte in said animal subject from said corrected signal.

Some embodiments include one or more of the following features. The Raman spectroscopy is coherent. The illuminated portion of said animal subject is imaged to help locate where the said reference analyte and target analyte may be present in the animal subject. Illuminating said portion of said animal subject with light may include focusing said light to a focal plane in said portion of said animal subject. Detecting said scattered radiation from said reference analyte may include collecting scattered radiation from said focal plane. The focusing of light may be to a point or to a line at said focal plane of said portion of said animal subject. Illuminating said portion of said animal subject with light may include scanning said light across said portion of said animal subject. The reference analyte may naturally exist in said animal subject or does not naturally exist in said animal subject. Said detection of said scattered radiation is non-invasive or partially-invasive. The detection may be performed through a subcutaneous probe or performed on a biopsy. The portion of said animal subject may be skin or a wound culture. The portion of said animal subject may be at least one member selected from the group consisting of tissue, secretion products, excretion products, exogenous material, aminiotic fluid, bile, blood, blood plasma, cerumen, cowper's fluid, chyle, chyme, lymph, menses, breast milk, mucus, pleural fluid, pus, sebum, serum, urine, saliva, semen, sweat, tears, stool, ocular aqueous humor, pulmonary exhalate, phlegm, gastrointestinal gavage, pulmonary gavage, and skin, stem cells, bone marrow, cerebral spinal fluid, and transplant tissue. The method is operable to identify in said portion of said animal subject at least one member selected from the group consisting of a chromosomal composition, metabolite, blood gas, biomarker, bacteria, virus, infectious disease biomarker in a fetus, meningitis, subarachnoid hemorrhage, hydrocephalus, benign intracranial hypertension, cancer, inflammation, Multiple Sclerosis/Guillian-Barre, neurosyphillis, Down syndrome, Tay-Sachs, cystic fibrosis, genetic disease arising from chromosomal deletion, duplication, translocation, inversion, or ring formation, cholesterol, triglycerides, C-reactive protein, bilirubin, alkaline phosphatase, alanine aminotransferase, AST/GOT, TSH, creatinine, albumin, CK-MB, myoglobin, troponin I, B-type Natriuretic Peptide (BNP), cancer specific markers, cancer antigens, prostate specific antigen (PSA), cell count, cell morphology, pharmaceutical composition, or a therapeutic drug. The reference analyte may be Hb1Ac. Urine may be illuminated under flow conditions. The target analyte may be creatinine.

Under another aspect, we describe a system to measure the concentration of a target analyte using Raman spectroscopy, which includes a source of illumination that can cause radiation to scatter from a reference analyte and a target analyte in a sample; a detector to measure said scattered radiation from said reference analyte and from said target analyte; and a processor to calculate an attenuation factor based on said measure of scattered radiation from said reference analyte, to correct said measure of scattered radiation from said target analyte based on said attenuation factor; and to determine an absolute concentration of said target analyte in said animal subject from said corrected measure of said target analyte.

Some embodiments include one or more of the following features. The source of illumination may be a coherent Raman laser system. An imaging system may be used to help locate a suitable location in said sample to illuminate said reference analyte and said target analyte. Scanning optics to scan said light across a portion of said sample. An endoscope may be optically coupled to said source of illumination, and said detector. The source of illumination is capable of illuminating a sample of blood and detecting scattered radiation from said sample to monitor a blood glucose level in real time.

Some embodiments provide systems and methods for prenatal diagnosis of chromosomal abnormalities, infectious disease, or blood characteristics in a manner less invasive than current methods so that fetal losses could be reduced. Some embodiments provide systems and methods to detect and to identify bacterial or viral populations, particularly bacterial infection of the deep skin, called cellulitis, in a manner more rapid than culture methods. Some embodiments provide less invasive systems and methods than lumbar punctures to assess the cerebral spinal fluid to diagnose in particular meningitis, or to aid in the clinical development of biomarkers for Alzheimer's disease and Parkinson's disease. Some embodiments provide continuous real-time, non-invasive systems and methods to measure arterial blood gas values, in particular PaCO2, to assess pulmonary function. Some embodiments provide systems and methods for real time quantitative determination, and time course data histories, of cardiac biomarkers to assess rapidly cardiac muscle damage, and to aid in the diagnosis of acute myocardial infarction (MI), congestive heart failure (CHF), or stratification of acute coronary syndromes (ACS). Some embodiments provide systems and methods for automated real time continuous monitoring of blood glucose levels to enable intensive insulin therapy and glycemic control to reduce mortality especially post surgery. Some embodiments provide systems and methods for automated real time continuous and non-invasive monitoring of blood glucose levels to enable superior insulin therapy and glycemic control. Some embodiments provide non-invasive systems and methods to determine a complete blood count (CBC) to reduce pain and discomfort especially for pediatric cases. Some embodiments provide systems and methods to obtain directly the instantaneous creatinine flow rate (CFR) from creatinine concentration levels in urine under flow conditions to provide an early indicator of renal failure or to assist in the dosing of drugs such as aminoglycosides. Some embodiments provide systems and methods to calibrate the concentration of the molecules detected.

### BRIEF DESCRIPTION OF THE DRAWINGS

FIG. 1A is a schematic view of a CARS system for measuring in vitro samples.

FIG. 1B is a schematic view of an implementation of the CARS system of FIG. 1A.

FIG. 2 is a schematic view of a CARS system for measuring samples under flow.

FIG. 3 is a schematic view of a CARS system for measuring at surfaces, and having focus depth control.

FIG. 4 is a schematic view of a CARS system that includes three-dimensional imaging guidance.

FIG. 5 is a schematic view of a CARS system that includes three-dimensional imaging guidance and an endoscopic attachment.

### DETAILED DESCRIPTION

An optical, non-invasive, non-destructive system and method to detect molecules, in particular physiological analytes or biomarkers that are ex vivo, in vivo, or both, is provided. Specifically, coherent Raman techniques are used to perform otherwise difficult medical diagnostics or therapeutic treatments.

In one aspect, a method for optically measuring molecules in a sample is disclosed whereby molecular species are identified and quantified by coherent Raman spectroscopy (CARS). CARS techniques potentially enhance the molecular signal from a sample by several orders of magnitude compared to the normal form of Raman spectroscopy, while eliminating non-resonant background, reducing measurement time, and enabling real-time analysis. Because of the optical nature of the technique, non-invasive detection is possible.

The detection of analytes in vivo is complicated by the fact that biological tissue scatters and otherwise attenuates the light used for the measurement, which can significantly reduce the CARS optical signal and thus the accuracy of the measurement. Additionally, the CARS signal that an in vivo analyte generates depends not only on the concentration of the analyte, but also on the temperature, hydration, and composition surrounding the analyte. A calibration technique is provided that can significantly enhance CARS signal and correct for dynamic variations in the in vivo subject that would otherwise inhibit measurement of the analyte.

First, several CARS systems are described. Then, the calibration method is described.

Further information on CARS systems can be found in “Optimizing the Laser-Pulse Configuration for Coherent Raman Spectroscopy,” Dmitry Pestov, Robert K. Murawski, Gombojav O. Ariunbold, Xi Wang, Miaochan Zhi, Alexei V. Sokolov, Vladimir A. Sautenkov, Yuri V. Rostovtsev, Arthur Dogariu, Yu Huang, and Marlan O. Scully (13 Apr. 2007) Science 316 (5822), 265, the entire contents of which are incorporated herein by reference.

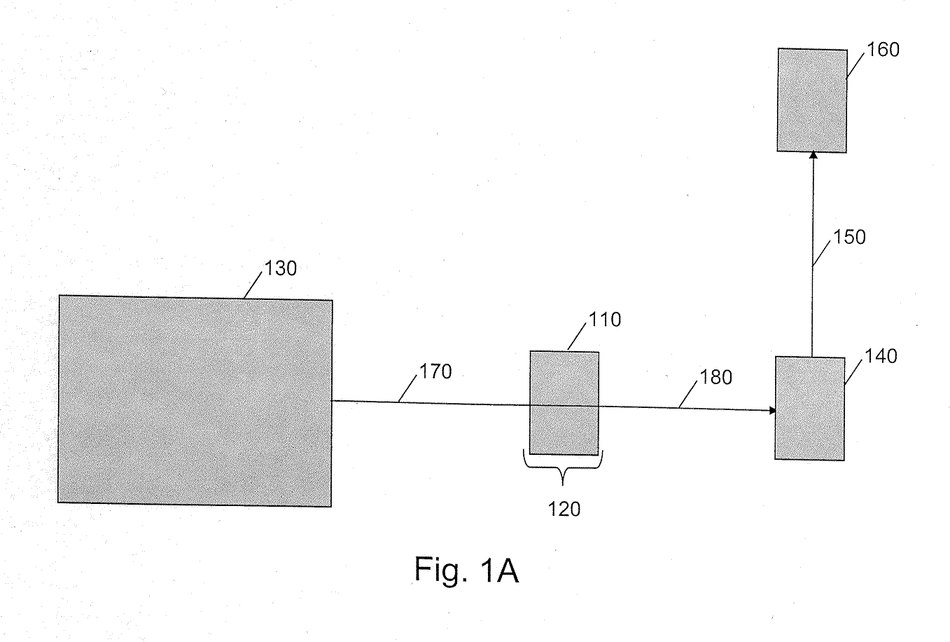

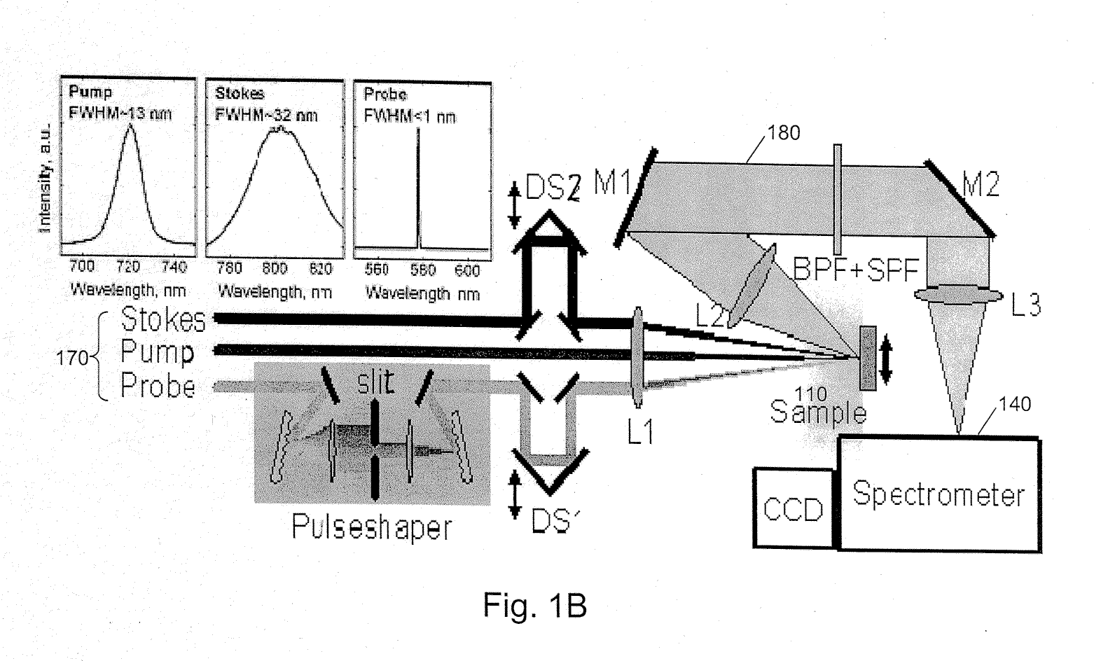

FIG. 1A is a schematic view of a transmission-mode CARS system, which can be used for ex vivo measurements, for example. A sample 110 is placed into sampling position 120. Light pulses 170 are generated from a coherent Raman laser system 130 and illuminated on sample 110. The scattered light 180 arising from the interaction of light pulses 170 with the sample 110 is collected and measured by detector 140. The signal 150 from the detector 140 in response to the measured light is analyzed by a microprocessor 160. The signal 150 may be pre-processed by another subsystem, to extract or subtract, for example, the contribution to signal by constituent components of the sample 110. Detector 140 is a multi-channel monochromator to record simultaneously the signal from a plurality of optical frequencies within the band of interest. Alternatively, the detector is a scanning single-channel monochromator, which detects single optical frequencies. The frequency range of interest is swept by the scanning single-channel monochromator to measure the emitted Raman signal. Alternatively, a time-resolved, delayed-probe configuration can be used to measure the response in time of the molecule, and from that the concentration of the analyte can be determined. Other detection schemes can also be used.

In the transmission-mode system illustrated in FIG. 1A, light is transmitted through the sample or area of interest, and the scattered light is measured on the side opposite to the light source. The sample is at least partially transparent to the probe beam. An ex vivo analysis can be performed, for example, by placing the sample into an optical cuvette, or by placing the sample between two glass slides with a gap in between, and at least partially sealing the assembly to contain the sample. Although FIG. 1A illustrates a transmission mode system, alternatively, backscattered light from the sample, or light that is reflected from a mirror placed on the opposite side of the sample and passed through the sample again, may be collected by a detector on the same side as the light source.

FIG. 1B schematically illustrates an exemplary implementation of the system of FIG. 1A, in a reflection-mode configuration, in which the probe light reflects from the sample surface instead of transmitting through the sample. In the system of FIG. 1B, coherent Raman system 130 (not shown) includes a Ti:Sapphire regenerative amplifier (Legend, Coherent: 1 kHz rep. rate, ˜1 mJ/pulse), that evenly pumps two optical parametric amplifiers (OPAs) (OPerA-VIS/UV and OPerA-SFG/UV, Coherent). The output of the first OPA (λ₁=712-742 nm, tunable; FWHM˜12 nm) and a small fraction of the amplifier output (λ₂=803 nm, FWHM˜32 nm) are used as pump and Stokes beams, respectively. The output of the second OPA is used as a probe beam (λ₃=578 nm) and sent through a pulse shaper, such as an adjustable slit that modulates the bandwidth of the pulse.

The Stokes and probe pulses pass through delay stages (DS1, DS2) that adjust their relative timing appropriately, and then all three beams 170 are focused by a convex 2-inch lens L1 (focal length f=200 mm) onto a sample 110. The scattered light 180 is collected with a 2-inch achromatic lens (f=100 mm) and focused onto the entrance slit of a spectrometer 140 (Chromex Spectrograph 250is) with a liquid nitrogen cooled charge-coupled device (CCD: Spec-10, Princeton Instruments) attached. The spectrometer 140 records information about the scattered light 180, i.e., a spectrum. The spectrum provides a “fingerprint” of the molecules present in the sample that provided a detectable response to the beams. Spectrometer 140 is in communication with a computer system (not shown) that digitally stores the spectrum, and analyzes it. Based on the size of the analyte's signal in the spectrum, the computer system determines how much analyte of interest is present. As described in greater detail below, the computer system can optionally calibrate the magnitude of the analyte's signal based on the magnitude of the signal of a “reference” analyte that is also present in the sample. After quantifying the amount of analyte in the sample, the computer system, or a user using the system, can suggest a course of treatment based on the amount of the analyte, or can suggest further measurements that would be helpful in assessing the health of the patient.

The probe pulse can be spectrally narrowed in order to reduce the signal from molecules besides the analyte, for example as described in the above-referenced Science article. To remedy in part the sacrifice of pulse energy lost by the slit, a thicker nonlinear crystal can be used for the frequency conversion process that produces the probe pulse, which results in a narrower probe spectrum to start with and therefore higher throughput of the pulse shaper. The second OPA could also, alternatively, be replaced with a second harmonic crystal, placed in the fundamental beam. One could alternatively use other wavelengths simultaneously generated in the first OPA to simplify the setup.

Alternatively, the pulses can be generated by a single laser, the light from which is passed through a pulse shaper. The pulse shaper divides a single laser pulse into the two pump pulses and the probe pulse, adjusts the spectral content of the pulses as desired, and introduces the desired temporal delay between the pulses as desired. Suitable pulse shaping techniques are known in the art.

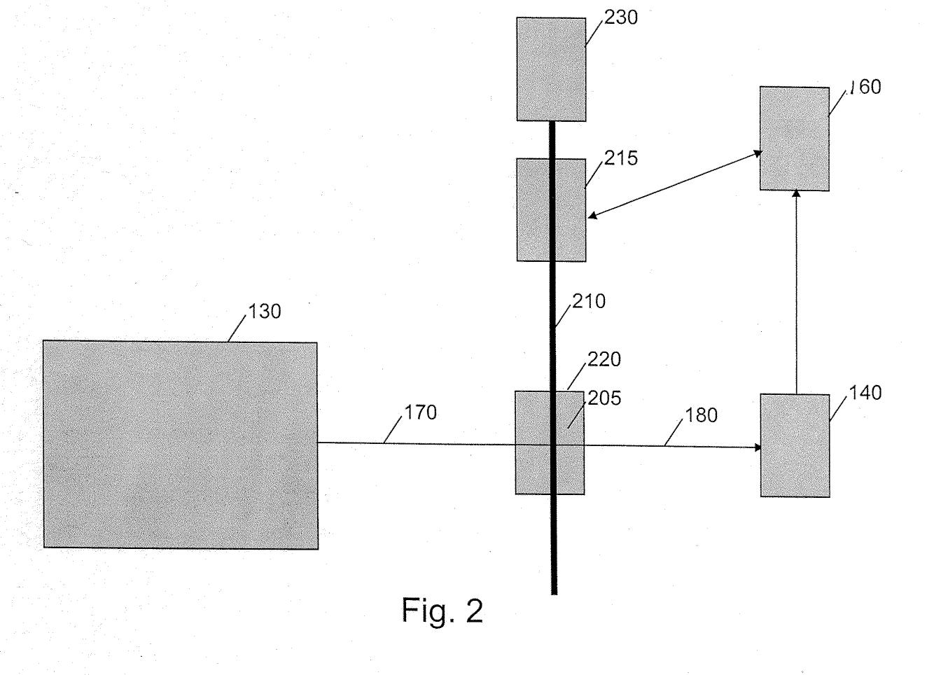

FIG. 2 schematically depicts a CARS system similar to the one illustrated in FIG. 1A, but in which the analyzed material 205 is instead in a flow stream 210. The material 205 may be either a solid or gas that is dissolved into a liquid, a liquid, or a gas, e.g., a bodily fluid, such as blood, plasma, amniotic fluid, or spinal fluid, or a synthetic material such as a pharmaceutical liquid. Reservoir 230 may hold the material 205 in solid form before it is mixed with a fluid medium, and flowed through a flow cell 220 as a flow stream 210. Alternatively, material 205 may be held in reservoir 230 as a liquid or gas that is diluted by a diluent before it is flowed through flow cell 220. Alternatively, material 205 held in reservoir 230 may itself be a gas or liquid that is undiluted when flowed through flow cell 220. Constituents of the analyzed material 205 can also be labeled to facilitate identification of a target molecule or molecular species. The reservoir 230 may be a human's body, an animal subject, a tank, bottle, or any other suitable vessel to hold material 205.

The flow rate of flow stream 210 is optionally measured by flow detector 215. The flow rate may be measured by any conventional means known to those skilled in the art, including, but not limited to: laser Doppler flow measurement, coriolis flow meters, ultrasonic flow meters, magnetic flow meters, and mechanical flow meters. Although not required, the flow detection may be measured by a flow detector 215 and electronically communicated to processor 160 for analysis.

Material 205 is flowed in a flow stream 210 through a flow cell 220 having suitable optical properties to permit optical measurement of the analyzed material 205, i.e., is at least partially transparent to the pump and probe pulses. Flow cell 220 may be, for instance, a quartz, glass, or plastic flow cell. Flow cell 220 may alternatively be a catheter, microfluidic chip, or any other suitable optically transparent flow cell known to those skilled in the art. It should be noted that the use of a flow cell is not required for all flow measurements. For example, flow stream 210 could be a jet stream with low turbulence, such as those similarly used in dye lasers. Methods to form an optically acceptable jet stream will be evident to those skilled in the art.

Flow stream 210 may be either recycled and sent to reservoir 230, or directed to waste (not shown). Light 170 from the coherent Raman laser system 130 is passed through flow cell 220. Raman signal 180 is detected by detector 140. The signal from detector 140 is sent to microprocessor 160 to be analyzed.

Optical non-invasive techniques, such as coherent Raman spectroscopy, return signals from which the concentration of the analyte can be quantified. For example, in coherent Raman spectroscopy, the intensity of the signal is proportional to the concentration of the analyte. However, the usefulness of Raman spectroscopy for quantitatively measuring analytes in biological materials, particularly in vivo, can be confounded by attenuation, scatter, and spurious contribution to signal by skin and other tissue. Confocal focusing provides one way to limit the unwanted contribution. In a basic type II confocal configuration, an objective lens forms an image of a pinhole onto a specimen at a sample plane, which is subsequently imaged by the same lens onto a detector pinhole. By positioning pinholes on the microscope optical axis in conjugate focal planes, detection is substantially limited to emission or scatter occurring near the focal plane by the detector pinhole aperture, which substantially rejects out-of-focus light from outside the focal plane. Such a measurement system effectively records primarily the light reflected or transmitted within a material from a volume having the shape of an ellipsoid. The long axis of the focal ellipsoid is in the optical flow or z-axis and can be, for example, approximately double the length of the x- and y-axes. The volume being “interrogated” by the confocal optical system is set to a desired value by selecting an appropriate numerical aperture of the confocal optical system. The numerical aperture can be relatively large, e.g., about 0.9.

Type II confocal configurations enable Raman spectra to be determined from a known volume of material. If the material is homogeneous (e.g., blood), then doubling the confocal volume approximately doubles the height of each peak in the Raman spectrum. If the attenuation through the skin can be measured or modeled accurately enough, the absolute concentration of a molecular species probed by the Raman confocal system can be determined. A Raman confocal optical system may thus be able to determine the relative and absolute concentration of a molecular species (e.g., a blood analyte such as glucose).

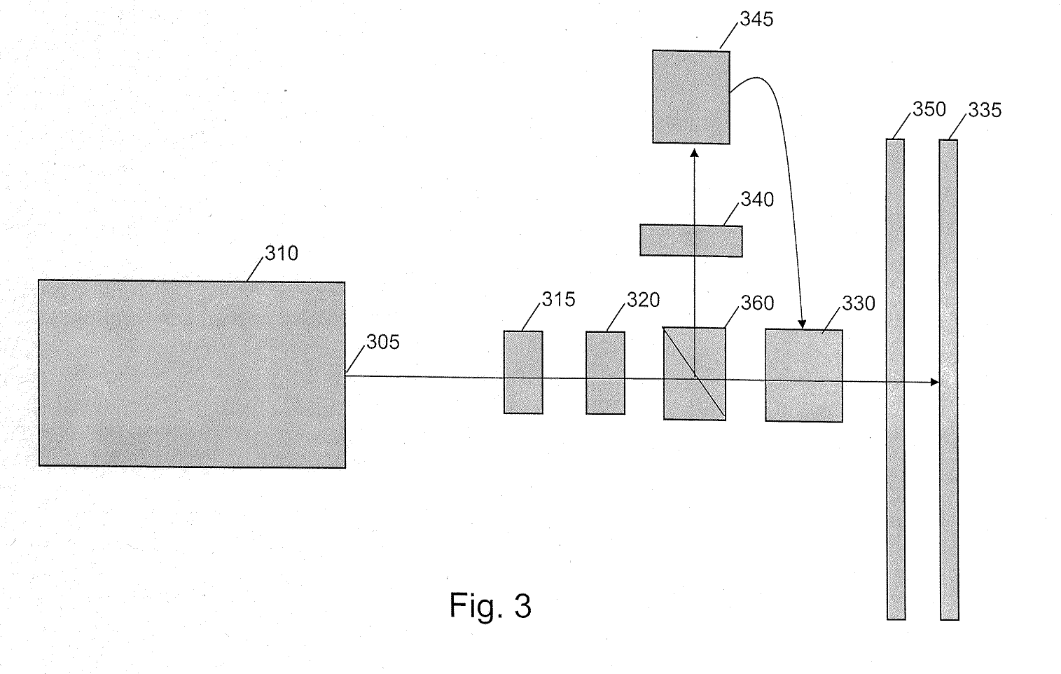

FIG. 3 is a schematic illustration of an embodiment in which signal is acquired by a type II confocal system. In point-scan mode, only a spot on the sample is analyzed. To enable confocal imaging of a specimen in two or three dimensions, the spot sampled within the specimen should be moveable, and the resulting signal collected and stored. Light 305 from coherent Raman laser system 310 is manipulated with scanning optics 315 to help scan the sample, and thus construct a confocal image of it.

Light 305 typically includes a pair of preparation (pump) pulses and a probe pulse, e.g., as described with reference to FIGS. 1A, 1B, and 2. The preparation and probe pulses are each ultrashort in duration, e.g., less than about a picosecond. Alternatively, the preparation pulses are ultrashort, e.g., femtosecond pulses, while the probe pulse is temporally stretched, either by phase shifting the spectral components of the probe, or otherwise spectrally narrowing the frequency bandwidth of the probe with, for example, an optical bandwidth filter, slit or any other type of spatial light modulator known to those skilled in the art.

Scanning optics 315 may include one or more scanning mirrors that are oscillated electromechanically by a moving-coil mechanism similar to that of a galvanometer, to help raster scan a sample. After being manipulated by scanning optics 315, light 305 passes through pinhole aperture 320, which is in the rear focal plane of objective lens 330. Objective lens 330 focuses light 305 through sample surface 350 onto focal plane 335. Light emitted or back scattered from the sample near the focal plane is imaged by objective lens 330 and directed by a dichroic mirror or beamsplitter 360 toward pinhole aperture 340, which is located at the rear conjugate plane of objective 330 to help reject light from the volume outside of the focal plane 335. The emitted or scattered light that passes through pinhole aperture 340 may then be detected by detector 345. In another confocal configuration, pinhole apertures 320 and/or 340 are functionally replaced by the non-linear response of the coherent Raman process in the sample, i.e., only the focal spot has sufficient intensity light to provide a CARS signal.

Confocal scanning operation of a coherent Raman system can be achieved by employing a translating sample stage (not shown), and holding light 305 substantially stationary (stage scanning). Other configurations that provide relative motion of the light 305 and the sample can be used. For example, scanning optics 315 may comprise a scan mirror that is located in the rear focal plane of a scanning lens, which is conjugate with the rear focal plane of the objective lens 330. Or, for example, objective lens 330 may itself be scanned over a stationary sample, and light 305 held substantially stationary (scanned-lens system). In a further alternative embodiment, two scanning mirrors (not shown) are employed in scanning optics 315. Depending on the distance and type of mirrors used, an optical relay system may be required to communicate light 305 between the two mirrors.

The position of the focal plane 335 within the sample (e.g., depth of the focal plane) is controlled by the objective lens 330, which optionally is informed by the signal observed by detector 345. For instance, if a user wanted to place the focal plane at the sub-stratum corneum layer in the skin, the objective lens 330 can be moved until the Raman signal from hemoglobin in the capillaries is detected. Once at the desired depth, a search for indicators of bacterial markers, such as lipopolysaccharides, may commence.

As mentioned previously, signals obtained from in vivo samples can be dynamically attenuated by factors such as temperature, hydration, and composition. The calibration technique described in greater detail below can be used with the system of FIG. 3, or any of the other systems described herein, in order to enhance the accuracy of the measurement.

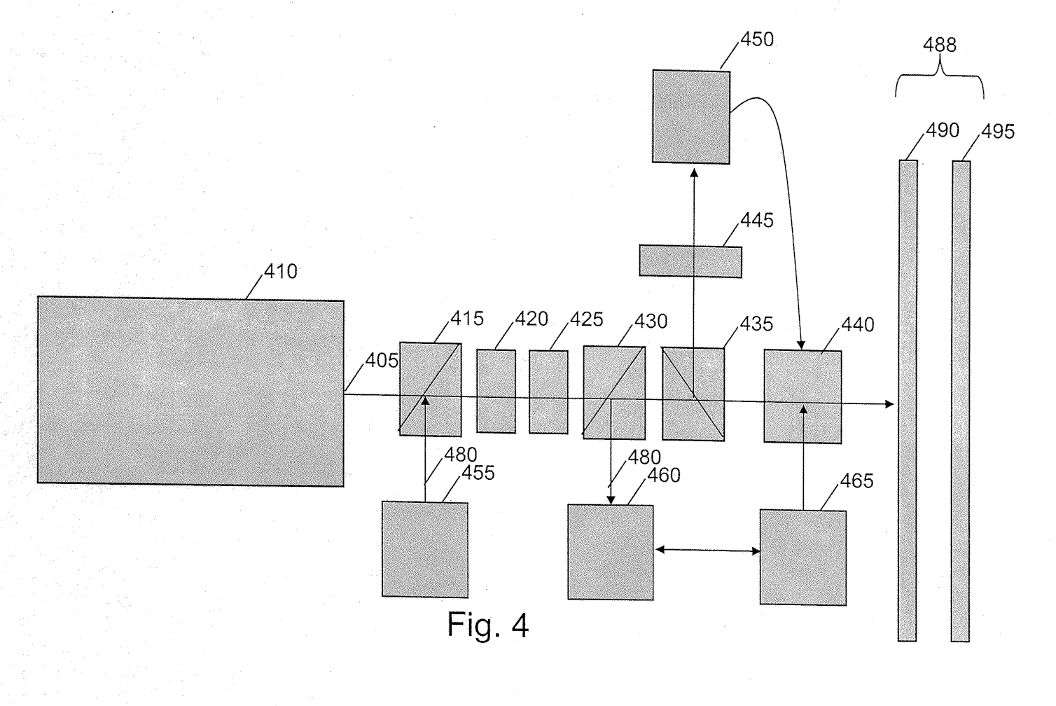

FIG. 4 is a schematic of a CARS system that is adapted for image guided spectral detection. A coherent Raman system is combined with an imaging system. Imaging light source 455 directs imaging light 480 to a dichroic mirror 415 so that it is substantially colinear with light 405. Light source 455 is, for example, a white light source, a diode, or a laser. Light 405 from coherent Raman laser system 410 and imaging light 480 are directed through scanning optics 420. Scanning optics 420 may be the same or similar to scanning optics 315 described above. Light 405 and imaging light 480 pass through pinhole aperture 425, and are focused by objective lens 440 to illuminate sample 488. The light at least partially transmits through a sample surface 490, such as human skin and tissue, and focuses onto focal plane 495 within the sample 488, e.g. inside a human or animal subject. As used in the claims, “animal subject” refers to both humans and animals.

The Raman signal from the illuminated volume near focal plane 495 is directed by dichroic mirror or beamsplitter 435 through pinhole aperture 445 to detector 450. Pinhole aperture 445 is located in the rear focal plane of objective lens 440. In another embodiment, the detector pinhole is not necessary, since the non-linear CARS process generates a tight focal volume. Also, the non-descan section allows the detector to be close to the objective lens. Imaging light 480 that is reflected or scattered from the focal plane is imaged by objective lens 440, and directed by dichroic mirror 430 to imaging detector 460, such as a CCD or CMOS camera. The signal generated by the imaging detector 460 is sent to image processor controller 465 for analysis. Image processor controller 465 also communicates with objective lens 440 and/or with a sample translation stage, if present (not shown), and can instruct lens 440 and/or the sample translation stage to move to a particular location in order to irradiate a sample portion of interest. Another suitable imaging system is described in U.S. Pat. No. 7,217,266, which is incorporated herein in its entirety by reference.

The embodiment of FIG. 3 may be suitable for use, for example, as part of a medical diagnostic or therapeutic treatment to locate a desired site, such as a blood vessel, within in the human body or animal subject. Once the desired site is located, a coherent Raman pulse sequence may be initiated to obtain the Raman spectrum of a target molecule within the irradiated volume. The present devices described herein are particularly well suited for measuring blood glucose levels, cardiac biomarkers, urine creatinine clearance rates, bacterial strain presence, and chromosomal abnormalities, or neurodegenerative disease biomarkers. The modifications needed to adapt the device for applications such as those listed above require no more than routine experimentation.

In an alternative configuration, coherent Raman laser system 405 may be also utilized in a multiplexed fashion for imaging. Specifically, a “Raman image” of the sample is obtained by obtaining a Raman spectrum from points across the sample. Each spectrum is a “fingerprint” of the molecules present at that point in the sample that responded to the beams. A computer system or a user can use these spectra to determine the structure of the sample, and then obtain additional measurements at a point of particular interest, e.g., to attempt to quantify the amount of an analyte of interest, that may be present at that point. For example, a “Raman image” may indicate that certain points in the sample contain substantially more collagen than hemoglobin, and that other points in the sample contain substantially more hemoglobin than collagen. The points with more hemoglobin likely contain blood vessels, and the user can then attempt to obtain additional information from the blood vessels, e.g., make a measurement of glucose in the blood vessels.

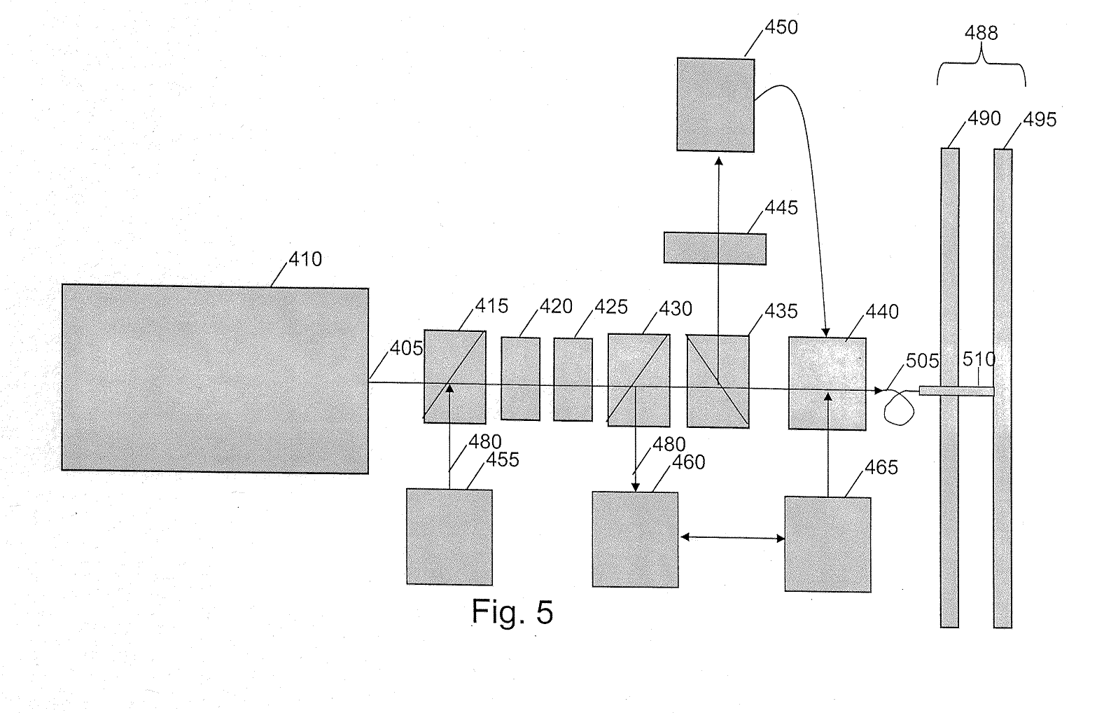

FIG. 5 is a schematic of another embodiment of a device that is adapted for endoscopically accessed spectral detection. The coherent Raman and imaging system of FIG. 4 is combined with an optical fiber 505 and endoscopic probe 510. Such a probe may be inserted, for instance, into the uterus to analyze amniotic fluid without puncturing the amniotic sac. Alternatively, the probe may be inserted through the abdomen. Both procedures would be guided by ultrasound imaging. Once a site is located where the probe can analyze the fetal tissue or amniotic fluid, a coherent Raman pulse sequence may be initiated to detect spectrally chromosomal markers for trisomy, or other genetic defect. The Raman signal from the fetal tissue or amniotic fluid could also be compared with the maternal tissue signal from the outer side of the amniotic membrane.

The devices described herein may be used for quantitative in vivo testing of biological fluids and tissue for determining biochemical or hematological characteristics, or measuring the concentration of proteins, hormones, carbohydrates, lipids, drugs, toxins, gases, electrolytes, etc. If the absolute concentration of the analyte was constant, a non-invasive measurement of the analyte would also be constant, and variations in the detected signal could be directly related to variations in the underlying analyte. This variation would depend only on the concentration of the analyte and the detection method. In practice however, the detected signal of a constant concentration of the analyte is not constant. Attenuation of the signal occurs as the signal transits from its source to the analytes and then to the detector. In the measurements described herein, when applied in vivo, the detected light must travel through various types of tissues, each of which attenuates the signal in a dynamic way. For example, the skin's temperature, hydration and analyte composition will all vary over time and can cause varying levels of attenuation. In addition, these variations might be different from persons to persons.

A calibration method can be used to correct for this dynamic attenuation. Specifically, to measure the absolute concentration of a physiologically or medically relevant analyte (“target analyte”), a reference analyte is used to calibrate a concentration measurement of the target analyte. The target analyte is assumed to have a commercial or standard method to determine their absolute concentration. The abundance of both the reference analyte and the target analyte can be detected at the target site by one or more of the noninvasive detection methods described herein. The concentration of the target analyte can be measured by any conventional means known to those skilled in the art, such as an enzymatic assay, HPLC, electrochemical assay, or mass spectrometry. The concentration of the selected reference analyte should not change significantly over time (e.g., does not change significantly over a time period greater than a day, or greater than a week), and, in one embodiment, occurs naturally in the body. In general, however, many naturally occurring analytes will vary over time. Either a synthetic or a naturally occurring analyte may also be used provided its concentration does not change or changes slowly relative to the desired observation period (τ).

In one embodiment, the calibration method includes the following:
1. The target analyte is first measured at time (t₀) using an appropriate conventional method to initially measure the absolute concentration of the target analyte [C_{T}(t₀)].
2. At or about the same time, the signals from the reference analyte [S_{R}(t₀)] and target analyte [S_{T}(t₀)] are measured by one of the non-invasive techniques described herein, e.g., using the system of FIG. 3 to measure the signals from a human or animal subject.
3. The signals from reference analyte [S_{R}(t)] and target analyte [S_{T}(t)] are measured at a later time (t), where t₀≦t≦τ.
4. The attenuation factor at time (t) is calculated according to the following formula: α_{R}(t,t₀)=[S_{R}(t₀)]/[S_{R}(t)]. This gives the relative attenuation of the reference signal. We assume C_{R}(t) is slowly varying in time, that is, C_{R}(t)=C_{R}(t₀).
5. We assume that the strength of the signal from the target analyte at time (t) experiences the same attenuation as the reference analyte, that is α_{T}=α_{R}. Thus, we correct S_{T}(t) by the following equation: S̅_{T}(t)=α_{R}(t,t₀)S_{T}(t)=α_{T}(t,t₀)S_{T}(t). S̅_{T}(t) is the signal from the target molecule had the attenuation not changed from time t₀ to t; the only contribution to the change in value is assumed to come from a concentration change of the analyte.
6. We assume that the signal is proportional to the concentration, that is, C(t) is proportional to S(t). Then, C_{T}(t)/ S̅_{T}(t)=C_{T}(t₀)/S_{T}(t₀), which implies that C_{T}(t)=[ S̅S_{T}(t)/S_{T}(t₀)]C_{T}(t₀)=α_{R}(t)[S_{T}(t)/S_{T}(t₀)]C_{T}(t₀).
7. Thus we can determine the absolute concentration measurement of the target molecule at time (t) by the following equation:

$$[ {C}_{T} ( t ) ] = \frac{{S}_{R} ( {t}_{0} ) {S}_{T} ( t )}{{S}_{R} ( t ) {S}_{T} ( {t}_{0} )} {C}_{T} ( {t}_{0} )$$

8. Repeat step 1 at the end of the desired time period (τ).

In this method, we assume that the reference signal is constant in the time window T, and that all signals within the optical window will suffer the same multiplicative attenuation. In practice, the latter assumption may not always hold true. A derived quantity that does satisfy the multiplicative attenuation assumption, and which can be equated with the concentration of the detected analytes, will suffice. For example, the intensity of a detected CARS signal is given by:

I_{CARS}(Ω)=(χ_{R}⁽³⁾(Ω))²+(χ_{NR}⁽³⁾)²+2Re(χ_{R}⁽³⁾(Ω))χ_{NR}⁽³⁾ . . .

The first term in this equation is a resonant term, which depends on the square of the number of target molecules, is frequency dependent, and is maximum on resonance. The second term is a non-resonant term, and is approximately frequency independent. The last term is dispersive, and can be shown to disappear on resonance. Far off resonance, the middle term can be isolated. Thus the derived quantity χ_{R}⁽³⁾(Ω)=\sqrt{I_{CARS}(Ω_{R})−I_{CARS}(Ω_{Off Resonance})} is proportional to the target molecule concentration, and will indeed satisfy the multiplicative assumption.

The spectroscopic methods and systems set forth here may be used, among other things, to non-invasively measure glucose concentrations in vivo. HbA1c may be used as a calibration standard. HbA1c is a subtype of hemoglobin A that is bound to glucose. The reverse reaction, or decomposition of glucose from hemoglobin proceeds relatively slowly, so that any buildup of this subtype will generally persist for roughly 4 weeks. HbA1c has a half life in human blood that is ˜120 days, and is suitable for use as a calibration standard in the non-invasive spectroscopic methods described herein. Other suitable and long-lived species, such as fructosamine, that may be employed in the methods described herein will be evident to those skilled in the art.

The systems and methods described herein can also be used, for example, to obtain coherent Raman signal from a urine sample contained in a flow tube. A catheter placed to collect the urine output from a patient can direct the flow past a flow meter, and then past an optically transparent section for Raman detection. In the case of creatinine clearance measurement in urine, the multiplicative product of the flow rate and instantaneous creatinine concentration gives a desired clearance rate, i.e., a desired volume of blood plasma that is cleared of creatinine per unit time. The absolute value of the creatinine concentration can be calibrated from a neighboring reference cell, from an internal marker such as urea, or from a combination of these methods.

The invention having been fully described, it will be apparent to one of ordinary skill in the art that many modifications and changes may be made to it without departing from the spirit and scope of the present invention. Other embodiments are within the following claims.

What is claimed is:

1. A method to measure the concentration of a target analyte in an animal subject using Raman spectroscopy comprising:
measuring ex vivo a concentration of a target analyte in an animal subject;
illuminating a portion of said animal subject with light so as to cause radiation to scatter from a reference analyte and said target analyte in said sample;
detecting said scattered radiation from said reference analyte and from said target analyte;
measuring an electrical signal corresponding to an amount of detected radiation from said reference analyte;
measuring an electrical signal corresponding to an amount of detected radiation from said target analyte;
calculating an attenuation factor based on said signal from said reference analyte;
correcting the signal of said target analyte based on the attenuation factor; and
determining an absolute concentration of said target analyte in said animal subject from said corrected signal.

2. The method of claim 1, wherein said Raman spectroscopy is coherent.

3. The method of claim 1, further comprising imaging said illuminated portion of said animal subject to help locate where said reference analyte and target analyte may be present in said animal subject.

4. The method of claim 1, wherein illuminating said portion of said animal subject with light includes focusing said light to a focal plane in said portion of said animal subject; and wherein detecting said scattered radiation from said reference analyte includes collecting scattered radiation from said focal plane.

5. The method of claim 4, wherein said focusing is to a point or to a line at said focal plane of said portion of said animal subject.

6. The method of claim 4, wherein illuminating said portion of said animal subject with light includes scanning said light across said portion of said animal subject.

7. A system to measure the concentration of a target analyte using Raman spectroscopy comprising:
a source of illumination that can cause radiation to scatter from a reference analyte and a target analyte in a sample;
a detector to measure said scattered radiation from said reference analyte and from said target analyte; and
a processor to calculate an attenuation factor based on said measure of scattered radiation from said reference analyte, to correct said measure of scattered radiation from said target analyte based on said attenuation factor; and to determine an absolute concentration of said target analyte in said animal subject from said corrected measure of said target analyte.

8. The system of claim 7, wherein said source of illumination is a coherent Raman laser system.

9. The system of claim 7, further comprising an imaging system to help locate a suitable location in said sample to illuminate said reference analyte and said target analyte.

10. The system of claim 7, further comprising scanning optics to scan said light across a portion of said sample.

11. The system of claim 7, further comprising an endoscope that is optically coupled to said source of illumination, and said detector.

12. The method of claim 1, wherein said reference analyte naturally exists in said animal subject or does not naturally exist in said animal subject.

13. The method of claim 1, wherein said detection of said scattered radiation is non-invasive.

14. The method of claim 1, wherein said detection is partially-invasive.

15. The method of claim 14, wherein said detection is performed through a subcutaneous probe or performed on a biopsy.

16. The method of claim 1, wherein said portion of said animal subject is skin or a wound culture.

17. The method of claim 1, wherein said portion of said animal subject is at least one member selected from the group consisting of tissue, secretion products, excretion products, exogenous material, aminiotic fluid, bile, blood, blood plasma, cerumen, cowper's fluid, chyle, chyme, lymph, menses, breast milk, mucus, pleural fluid, pus, sebum, serum, urine, saliva, semen, sweat, tears, stool, ocular aqueous humor, pulmonary exhalate, phlegm, gastrointestinal gavage, pulmonary gavage, and skin, stem cells, bone marrow, cerebral spinal fluid, and transplant tissue.

18. The method of claim 1, wherein said method is operable to identify in said portion of said animal subject at least one member selected from the group consisting of a chromosomal composition, metabolite, blood gas, biomarker, bacteria, virus, infectious disease biomarker in a fetus, meningitis, subarachnoid hemorrhage, hydrocephalus, benign intracranial hypertension, cancer, inflammation, Multiple Sclerosis/Guillian-Barre, neurosyphillis, Down syndrome, Tay-Sachs, cystic fibrosis, genetic disease arising from chromosomal deletion, duplication, translocation, inversion, or ring formation, cholesterol, triglycerides, C-reactive protein, bilirubin, alkaline phosphatase, alanine aminotransferase, AST/GOT, TSH, creatinine, albumin, CK-MB, myoglobin, troponin I, B-type Natriuretic Peptide (BNP), cancer specific markers, cancer antigens, prostate specific antigen (PSA), cell count, cell morphology, pharmaceutical composition, or a therapeutic drug.

19. The method of claim 1, wherein said reference analyte is Hb1Ac.

20. The system of claim 7, wherein said source of illumination is capable of illuminating a sample of blood and detecting scattered radiation from said sample to monitor a blood glucose level in real time.

21. The method of claim 17, wherein urine is illuminated under flow conditions.

22. The method of claim 21, wherein said target analyte is creatinine.
